(19) United States
(12) Patent Application Publication
(10) Pub. No.: US 2023/0376358 A1
(43) Pub. Date: Nov. 23, 2023

(54) METHOD AND APPARATUS FOR MANAGING LOAD OF NETWORK NODE

(71) Applicant: Telefonaktiebolaget LM Ericsson (publ), Stockholm (SE)

(72) Inventors: Huaisong ZHU, Beijing (CN); Xiaoshan XIE, Guangdong (CN); Yang LIU, Beijing (CN); Hongjing ZHANG, Beijing (CN)

(73) Assignee: Telefonaktiebolaget LM Ericsson (publ), Stockholm (SE)

(21) Appl. No.: 18/030,317

(22) PCT Filed: Oct. 10, 2020
(86) PCT No.: PCT/CN2020/120173

§ 371 Date: Apr. 5, 2023

(51) Int. Cl. G06F 9/50; G06F 9/48

(52) U.S. Cl. CPC G06F 9/5088; G06F 9/4806; G06F 2209/503

(57) ABSTRACT

Embodiments of the present disclosure provide methods and apparatus for managing load of a network node. A method performed at a first network node may comprise: determining (S101), by the first network node, whether to dispatch a task to another network node; transmitting (S102), by the first network node, to at least one network node including a second network node, a request of dispatching the task; receiving (S103), by the first network node, from the second network node, a response of accepting the task; transmitting (S104), by the first network node, to the second network node, at least one portion of the task; and receiving (S105), by the first network node, from the second network node, a result of executing the at least one portion of the task. According to embodiments herein, a network node may dispatch at least one portion of a task to another network node.

### TECHNICAL FIELD

The present disclosure relates generally to the technology of wireless communication, and in particular, to a method and an apparatus for managing load of a network node.

### BACKGROUND

This section introduces aspects that may facilitate better understanding of the present disclosure. Accordingly, the statements of this section are to be read in this light and are not to be understood as admissions about what is in the prior art or what is not in the prior art.

In the communication system, it is a trend to introduce more complicated data and/or computation technology, such as big data technology, so as to provide improved service for the users. Meanwhile, such big data technology may also bring more processing load for the communication system, since such big data technology usually needs both strong data storage capacity and strong calculation capability.

However, a lot of network nodes in the communication system are hard to be upgraded to have much stronger storage capacity and calculation capability.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Conventionally, when processing loads of a network become more, the network node needs to be upgraded, particularly concerning the hardware. However, a lot of network nodes in the communication system are hard to be upgraded.

Certain aspects of the present disclosure and their embodiments may provide solutions to these or other challenges. There are, proposed herein, various embodiments which address one or more of the issues disclosed herein. Improved methods and apparatuses are provided for managing load of a network node. The network node itself may need not to be upgraded greatly, even when relevant processing loads increase.

A first aspect of the present disclosure provides a method at a first network node, comprising: determining, by the first network node, whether to dispatch a task to another network node; transmitting, by the first network node, to at least one network node including a second network node, a request of dispatching the task; receiving, by the first network node, from the second network node, a response of accepting the task; transmitting, by the first network node, to the second network node, at least one portion of the task; and receiving, by the first network node, from the second network node, a result of executing the at least one portion of the task.

In embodiments of the present disclosure, the method further comprises: when the task comprises a memory task, transmitting, by the first network node, data to be stored to the second network node, when transmitting the at least one portion of the task; receiving, by the first network node, the data from the second network node, when receiving a result of executing the at least one portion of the task.

In embodiments of the present disclosure, the method further comprises: determining, by the first network node, whether to dispatch the task, based on an evaluation about a memory size and/or an occupation period of a memory of the first network node.

In embodiments of the present disclosure, the first network node determines to dispatch the task, when at least one partition of the memory is to be overflowed.

In embodiments of the present disclosure, the first network node comprises a first partition of a memory for a first occupation period; and/or a second partition of a memory for a second occupation period.

In embodiments of the present disclosure, the method further comprises: when the task comprises a computation task, transmitting, by the first network node, data to be processed with information about an algorithm for processing the data to the second network node, when transmitting at least one portion of the task; receiving, by the first network node, a result of processing the data from the second network node, when receiving a result of executing the at least one portion of the task.

In embodiments of the present disclosure, the computation task comprises an artificial intelligence task.

In embodiments of the present disclosure, the method further comprises: when the artificial intelligence task comprises a training or inferring task for a plurality of models, transmitting, by the first network node, information about a model of the plurality of models to the second network node, when transmitting at least one portion of the task; and transmitting, by the first network node, the plurality of models to a plurality of second network nodes, respectively.

In embodiments of the present disclosure, the method further comprises: when the artificial intelligence task comprises a training or inferring task for a model with a plurality of data sets, transmitting, by the first network node, the model and a data set of the plurality of data sets to the second network node, when transmitting at least one portion of the task; transmitting, by the first network node the model to a plurality of second network nodes; and transmitting, by the first network node, the plurality of data sets to the plurality of second network nodes, respectively.

In embodiments of the present disclosure, the method further comprises: dispatching, by the first network node, all portions of the task to the second network node; or dispatching, by the first network node, a plurality of portions of the task to a plurality of second network nodes respectively.

In embodiments of the present disclosure, the request of dispatching the task includes information about at least one of: a type of the task; a deadline requirement of the task; an estimate of resources required by the task; a transport bandwidth for transmitting and/or receiving; or a duration of the task.

In embodiments of the present disclosure, the method further comprises: transmitting, by the first network node, the request via a broadcast or multicast signalling.

In embodiments of the present disclosure, the first network node comprises an access network node.

A second aspect of the present disclosure provides a method at a second network node, comprising: receiving, by the second network node, from a first network node, a request of dispatching a task; transmitting, by the second network node, to the first network node, a response of accepting the task; receiving, by the second network node, from the first network node, at least one portion of the task; and transmitting, by the second network node, to the first network node, a result of executing the at least one portion of the task.

In embodiments of the present disclosure, the method further comprises: when the task comprises a memory task, receiving, by the second network node, data to be stored from the first network node, when receiving the at least one portion of the task; and transmitting, by the second network node, the data to the first network node, when transmitting a result of executing the at least one portion of the task.

In embodiments of the present disclosure, the method further comprises: when the task comprises a computation task, receiving, by the second network node, data to be processed with information about an algorithm for processing the data from the first network node, when receiving the at least one portion of the task; transmitting, by the second network node, a result of processing the data to the first network node, when transmitting a result of executing the at least one portion of the task.

In embodiments of the present disclosure, the computation task comprises an artificial intelligence task.

In embodiments of the present disclosure, the method further comprises: when the artificial intelligence task comprises a training or inferring task for a plurality of models, receiving, by the second network node, information about a model of the plurality of models from the first network node, when receiving at least one portion of the task; wherein the plurality of models are transmitted to a plurality of second network nodes, respectively.

In embodiments of the present disclosure, the method further comprises: when the artificial intelligence task comprises a training or inferring task for a model with a plurality of data sets, receiving, by the second network node, the model and a data set of the plurality of data sets from the first network node, when receiving at least one portion of the task; wherein the model is transmitted to a plurality of second network nodes; and wherein the plurality of data sets are transmitted to the plurality of second network nodes, respectively.

In embodiments of the present disclosure, the method further comprises: accepting, by the second network node individually or together with another network node, all portions of the task dispatched by the first network node.

In embodiments of the present disclosure, the request of transmitting the task includes information about at least one of: a type of the task; a deadline requirement of the task; an estimate of resources required by the task; a transport bandwidth for transmitting and/or receiving; or a duration of the task.

In embodiments of the present disclosure, the method further comprises: receiving, by the second network node the request via a broadcast or multicast signalling.

In embodiments of the present disclosure, the second network node comprises a core network node and/or a server.

A third aspect of the present disclosure provides a first network node, comprising: a processor; and a memory, the memory containing instructions executable by the processor, whereby the first network node is operative to: determine whether to dispatch a task to another network node; transmit, to at least one network node including a second network node, a request of dispatching the task; receive, from the second network node, a response of accepting the task; transmit, to the second network node, at least one portion of the task; and receive, from the second network node, a result of executing the at least one portion of the task.

In embodiments of the present disclosure, the first network node is further operative to perform the method according to any of embodiments above mentioned.

A fourth aspect of the present disclosure provides a second network node, comprising: a processor; and a memory, the memory containing instructions executable by the processor, whereby the second network node is operative to: receive, from a first network node, a request of dispatching a task; transmit, to the first network node, a response of accepting the task; receive, from the first network node, at least one portion of the task; and transmit, to the first network node, a result of executing the at least one portion of the task.

In embodiments of the present disclosure, the second network node is further operative to perform the method according to any of embodiments above mentioned.

A fifth aspect of the present disclosure provides a computer-readable storage medium storing instructions which when executed by at least one processor, cause the at least one processor to perform the method according to any one of embodiments above mentioned.

A sixth aspect of the present disclosure provides a first network node, comprising: a determining unit, configured to determine whether to dispatch a task to another network node; a first transmitting unit, configured to transmit, to at least one network node including a second network node, a request of dispatching the task; a first receiving unit, configured to receive, from the second network node, a response of accepting the task; a second transmitting unit, configured to transmit, to the second network node, at least one portion of the task; and a second receiving unit, configured to receive, from the second network node, a result of executing the at least one portion of the task.

In embodiments of the present disclosure, the first network node is further operative to perform the method according to any of embodiments above mentioned.

A seventh aspect of the present disclosure provides a second network node, comprising: a first receiving unit, configured to receive, from a first network node, a request of dispatching a task; a first transmitting unit, configured to transmit, to the first network node, a response of accepting the task; a second receiving unit, configured to receive, from the first network node, at least one portion of the task; and a second transmitting unit, configured to transmit, to the first network node, a result of executing the at least one portion of the task.

In embodiments of the present disclosure, the second network node is further operative to perform the method according to any of embodiments above mentioned.

Embodiments herein afford many advantages. For example, in embodiments herein, a network node may dispatch a task to another network node, so as to dynamically manage the load of the network node itself. The network node itself may need not to be upgraded greatly, even when relevant processing loads increase. A person skilled in the art will recognize additional features and advantages upon reading the following detailed description.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary flow chart showing a method performed at a first network node, according to embodiments of the present disclosure.

FIG. 1B is an exemplary flow chart showing additional steps of the method performed at the first network node, according to embodiments of the present disclosure.

FIG. 1C is an exemplary flow chart showing additional steps of the method performed at the first network node, according to embodiments of the present disclosure.

FIG. 1D is an exemplary flow chart showing additional steps of the method performed at the first network node, according to embodiments of the present disclosure.

FIG. 1E is an exemplary flow chart showing additional steps of the method performed at the first network node, according to embodiments of the present disclosure.

FIG. 1F is an exemplary flow chart showing additional steps of the method performed at the first network node, according to embodiments of the present disclosure.

FIG. 1G is an exemplary flow chart showing additional steps of the method performed at the first network node, according to embodiments of the present disclosure.

FIG. 1H is an exemplary flow chart showing additional steps of the method performed at the first network node, according to embodiments of the present disclosure.

FIG. 2A is an exemplary flow chart showing a method performed at a second network node, according to embodiments of the present disclosure.

FIG. 2B is an exemplary flow chart showing additional steps of the method performed at the second network node, according to embodiments of the present disclosure.

FIG. 2C is an exemplary flow chart showing additional steps of the method performed at the second network node, according to embodiments of the present disclosure.

FIG. 2D is an exemplary flow chart showing additional steps of the method performed at the second network node, according to embodiments of the present disclosure.

FIG. 2E is an exemplary flow chart showing additional steps of the method performed at the second network node, according to embodiments of the present disclosure.

FIG. 2F is an exemplary flow chart showing additional steps of the method performed at the second network node, according to embodiments of the present disclosure.

FIG. 2G is an exemplary flow chart showing additional steps of the method performed at the second network node, according to embodiments of the present disclosure.

FIG. 3A is an exemplary diagram showing a processing parallelism.

FIG. 3B is an exemplary diagram showing a fixed time relationship between the start and end of the processing.

FIG. 3C is an exemplary diagram showing no fixed time relationship between the start and end of the processing.

FIG. 4 is a diagram showing an exemplified processing flow for task dispatch, according to embodiments of the present disclosure.

FIG. 5 is a block diagram showing exemplary apparatuses suitable for practicing the network node according to embodiments of the disclosure.

FIG. 6 is a block diagram showing exemplary detailed apparatuses suitable for practicing the network node according to embodiments of the disclosure.

FIG. 7A is an exemplary diagram showing an offload scenario, according to embodiments of the disclosure.

FIG. 7B is an exemplary diagram showing a task for adjusting a coverage of the network, according to embodiments of the disclosure.

FIG. 8 is a block diagram showing an apparatus readable storage medium, according to embodiments of the present disclosure.

FIG. 9 is a schematic showing units for the network node, according to embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable wireless communication standards. For example, the wireless communication standards may comprise 5th generation (5G), new radio (NR), 4th generation (4G), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node” may also refer to any suitable function which can be implemented in a network entity (physical or virtual) of a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), OAM (Operation Administration and Maintenance) etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

When more complicated data and/or computation technology are introduced to communication network, the processing loads of the network become more obviously. Conventionally, the hardware and the software of relevant network nodes need to be updated accordingly.

For example, when various artificial intelligence, AI, use cases are deployed in the communication network, the cellular AI infrastructure may need to fulfil the following requirements: memory requirement, since AI need find ‘pattern’ from data (such as in day or week or even longer period level), and this in principle will introduce high memory cost; and computation capability, since currently most of AI application will consume 10× or 100× of complexity if compared with legacy no-AI solution, and expensive high-end processing chips are needed.

However, a lot of network nodes in the communication system are hard to be upgraded. For example, some nodes in the access network which need to be deployed in great number and remotely are hard to be upgraded with expensive hardware.

For example, in some access network node, such as a base station, the cellular baseband hardware (HW) (usually referred to as baseband unit (BBU) or digital unit (DU)) is designed and customized for efficient baseband processing for eMBB (Enhanced Mobile Broadband) protocols, e.g. LTE and NR. But as described previously, the requirements for cellular AI design are so different from eMBB. For example, the eMBB aims to low latency, big throughput, etc, but the AI tasks usually need big data storage and complicated computation (with much longer processing period).

Reusing the same HW designed for eMBB to execute the AI and eMBB tasks simultaneously can be highly inefficient, despite the advantage of fast deployment via software update.

Even though the AI processing latency requirement is relative lower than traditional eMBB processing but considering burst of AI processing is relative independent with eMBB. When 2 system's peak collision, the required resources for processing AI and eMBB simultaneously will be significantly increased.

Some AI functions are much more complex than those of eMBB. For example, the simple AI assistant link adaptation will consume around 300× computation cycle according to some study to achieve a good performance, which introduce a big burden to DSP (Digital Signal Processing). Data storage requires huge memory. This means the memory equipped in DU, especially in-chip memory, for eMBB may be not enough.

As a result, the baseband hardware resources are not efficiently utilized when using the same HW customized for eMBB. The baseband capacity (e.g. number of cells, number of users/devices per cell) may be limited when running AI and eMBB on the same hardware due to competition of the baseband resources, e.g. DSP cycles and memory.

In the current implementation, the DU would have to trigger admission control, not allowing more UEs to access, i.e. by RRC (radio resource control) signaling to reduce the air interface load, and thus avoid overloading the baseband processing of the DU.

Certain aspects of the present disclosure and their embodiments may provide solutions to these or other challenges. There are, proposed herein, various embodiments which address one or more of the issues disclosed herein. Improved methods and apparatuses are provided for managing load of a network node. The network node itself may need not to be upgraded greatly, even when relevant processing loads increase.

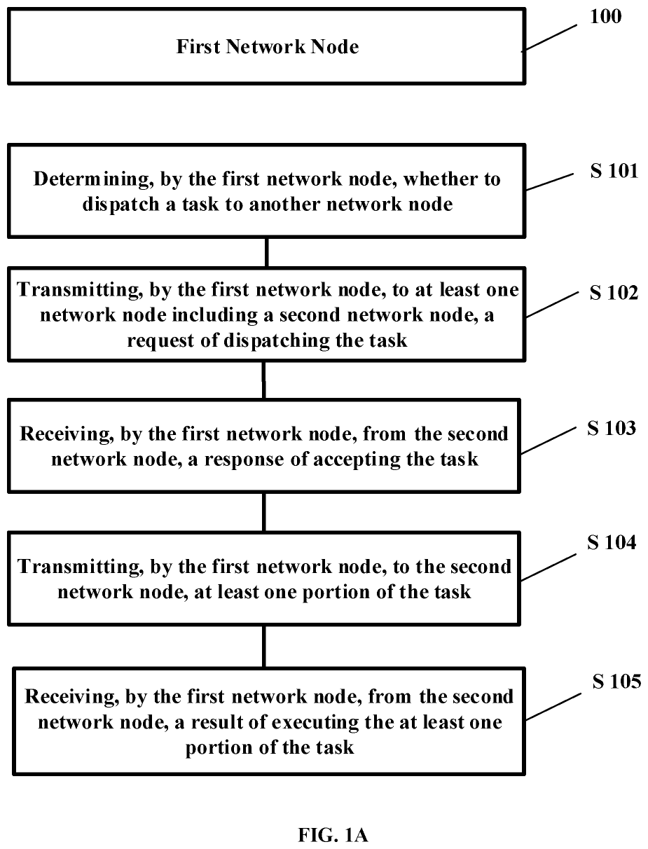

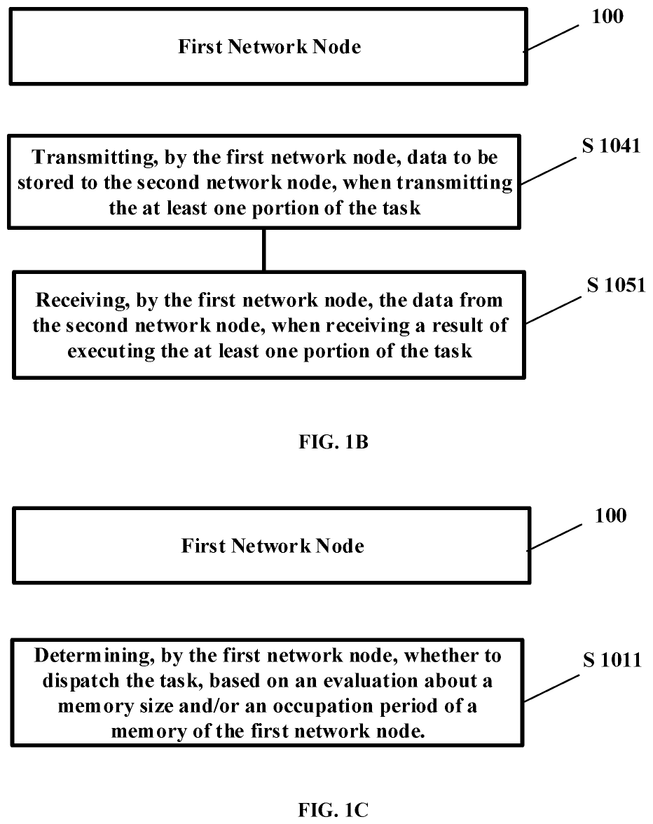

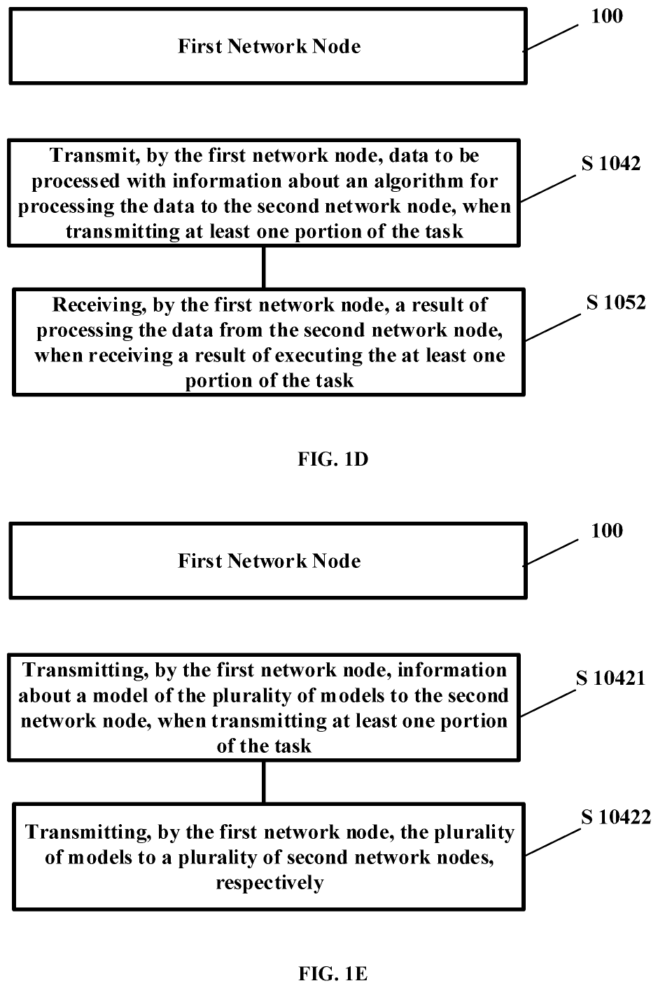

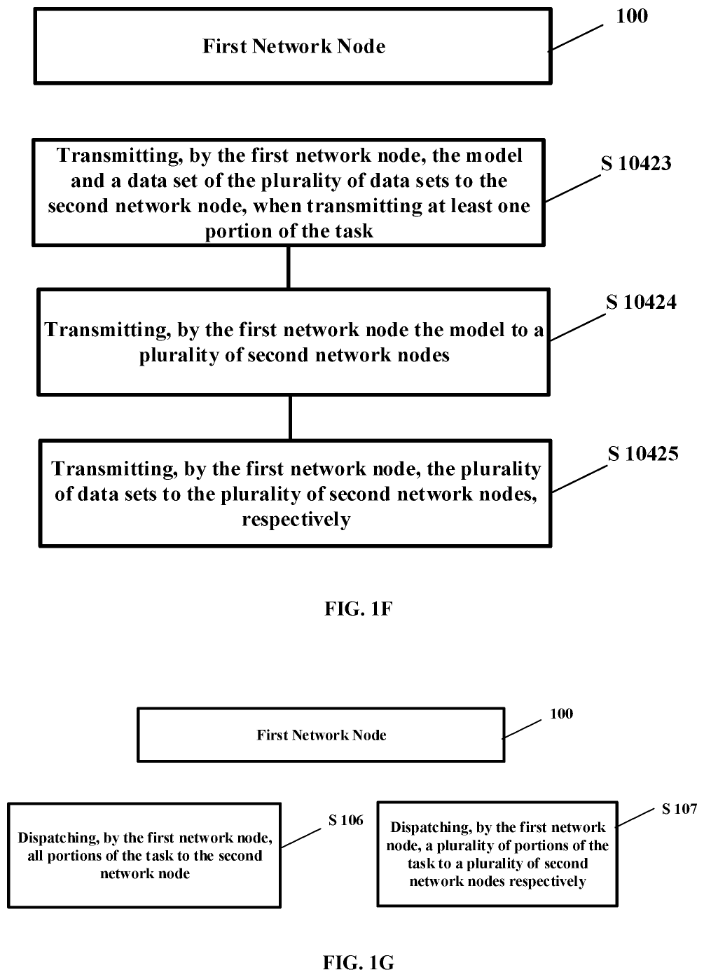

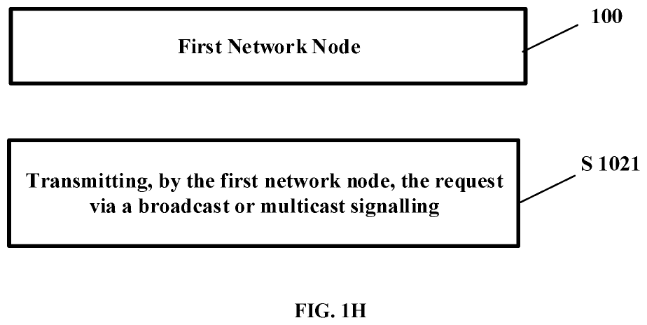

FIG. 1A is an exemplary flow chart showing a method performed at a first network node, according to embodiments of the present disclosure.

As shown in FIG. 1A, the method at a first network node may comprise: S101, determining, by the first network node, whether to dispatch a task to another network node; S102, transmitting, by the first network node, to at least one network node including a second network node, a request of dispatching the task; S103, receiving, by the first network node, from the second network node, a response of accepting the task; S104, transmitting, by the first network node, to the second network node, at least one portion of the task; and S105, receiving, by the first network node, from the second network node, a result of executing the at least one portion of the task.

Embodiments herein afford many advantages. For example, in embodiments herein, a network node may dispatch at least one portion of a task to another network node, so as to dynamically manage the load of the network node itself. The network node itself may need not to be upgraded greatly, even when relevant processing loads increase.

FIG. 1B is an exemplary flow chart showing additional steps of the method performed at the first network node, according to embodiments of the present disclosure.

In embodiments of the present disclosure, the task may comprise any kind of task, such as data storage/memory, or computation.

As shown in FIG. 1B, the method may further comprise: when the task comprises a memory task, S1041, transmitting, by the first network node, data to be stored to the second network node, when transmitting the at least one portion of the task; S1051, receiving, by the first network node, the data from the second network node, when receiving a result of executing the at least one portion of the task.

According to embodiments of the present disclosure, the first network node may dispatch a memory task to another network node. Therefore, the first network node needs not to be equipped with large data storage elements, even when some big data processing is performed at the first network node.

FIG. 1C is an exemplary flow chart showing additional steps of the method performed at the first network node, according to embodiments of the present disclosure.

As shown in FIG. 1C, the method may further comprise: S1011, determining, by the first network node, whether to dispatch the task, based on an evaluation about a memory size and/or an occupation period of a memory of the first network node.

In embodiments of the present disclosure, the first network node determines to dispatch the task, when at least one partition of the memory is to be overflowed.

In embodiments of the present disclosure, the first network node comprises a first partition of a memory for a first occupation period; and/or a second partition of a memory for a second occupation period.

According to embodiments of the present disclosure, the first network node may have different memory partitions for different purpose. When any of the memory partitions is going to be overflowed, the first network node may try to request help from other nodes by dispatching tasks relevant to the memory partitions, while other types of tasks relevant to other memory partitions are not influenced.

Further, the occupation period may be chosen as an indicator for whether a task is a normal eMBB task, or a time-consuming task (e.g. AI task).

FIG. 1D is an exemplary flow chart showing additional steps of the method performed at the first network node, according to embodiments of the present disclosure.

As shown in FIG. 1D, the method may further comprise: when the task comprises a computation task, S1042, transmitting, by the first network node, data to be processed with information about an algorithm for processing the data to the second network node, when transmitting at least one portion of the task; S1052, receiving, by the first network node, a result of processing the data from the second network node, when receiving a result of executing the at least one portion of the task.

According to embodiments of the present disclosure, concerning a computation task, the first network node may provide both data and algorithm for processing the data to the second network node. Therefore, the second network node, which accepts the task, need not any prior information or preparation. The security and/or the flexibility may be further improved.

FIG. 1E is an exemplary flow chart showing additional steps of the method performed at the first network node, according to embodiments of the present disclosure.

In embodiments of the present disclosure, the computation task may comprise an artificial intelligence task.

As shown in FIG. 1E, the method may further comprise: when the artificial intelligence task comprises a training or inferring task for a plurality of models, S10421, transmitting, by the first network node, information about a model of the plurality of models to the second network node, when transmitting at least one portion of the task; and S10422, transmitting, by the first network node, the plurality of models to a plurality of second network nodes, respectively.

According to embodiments of the present disclosure, a processing parallelism may be achieved, and thus particularly applicable for multi prediction ensemble algorithm, like random forest etc.

FIG. 1F is an exemplary flow chart showing additional steps of the method performed at the first network node, according to embodiments of the present disclosure.

As shown in FIG. 1F, the method may further comprise: when the artificial intelligence task comprises a training or inferring task for a model with a plurality of data sets, S10423, transmitting, by the first network node, the model and a data set of the plurality of data sets to the second network node, when transmitting at least one portion of the task; S10424, transmitting, by the first network node the model to a plurality of second network nodes; and S10425, transmitting, by the first network node, the plurality of data sets to the plurality of second network nodes, respectively.

According to embodiments of the present disclosure, a data parallelism may be also achieved, and thus particularly applicable for non-ensemble learning algorithm, e.g. neural network training.

FIG. 1G is an exemplary flow chart showing additional steps of the method performed at the first network node, according to embodiments of the present disclosure.

As shown in FIG. 1G, the method may further comprise: S106, dispatching, by the first network node, all portions of the task to the second network node; or S107, dispatching, by the first network node, a plurality of portions of the task to a plurality of second network nodes respectively.

According to embodiments of the present disclosure, the first network may obtain assistance from one second network node, or a plurality of network node, for one task.

In embodiments of the present disclosure, the request of dispatching the task includes information about at least one of: a type of the task; a deadline requirement of the task; an estimate of resources required by the task; a transport bandwidth for transmitting and/or receiving; or a duration of the task.

Therefore, the second network node which are capable/suitable for the task may accept the task correspondingly.

FIG. 1H is an exemplary flow chart showing additional steps of the method performed at the first network node, according to embodiments of the present disclosure.

In embodiments of the present disclosure, the method further comprises: S1021, transmitting, by the first network node, the request via a broadcast or multicast signalling.

In embodiments of the present disclosure, the first network node comprises an access network node, such as a node B (NodeB or NB), an evolved NodeB (eNodeB or eNB), a next generation NodeB (gNodeB or gNB), etc.

According to embodiments of the present disclosure, it is possible for the first network node to obtain assistance from any unspecified second network node (with storage and/or computation capability). It should be understood, the first network node may also transmit the request via a dedicated signalling/message to a specific second network node.

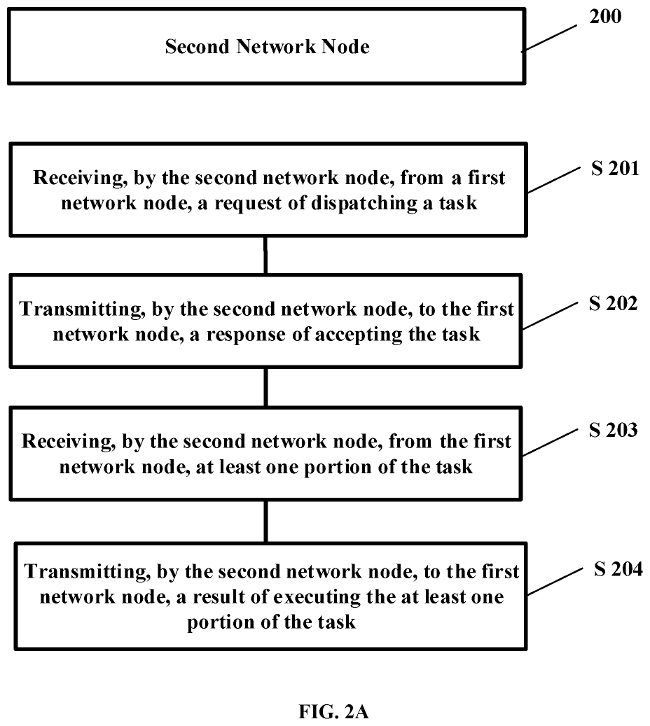

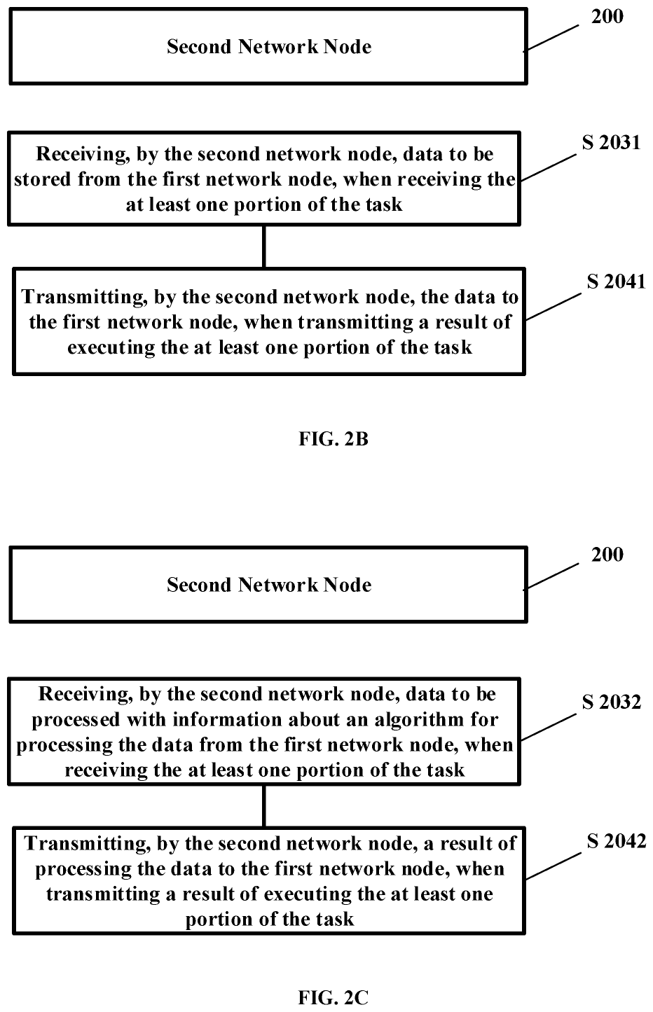

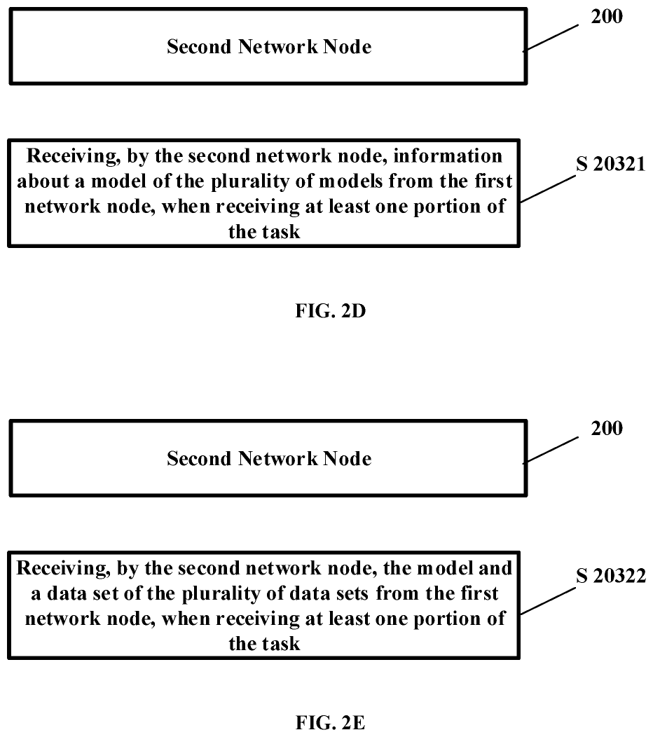

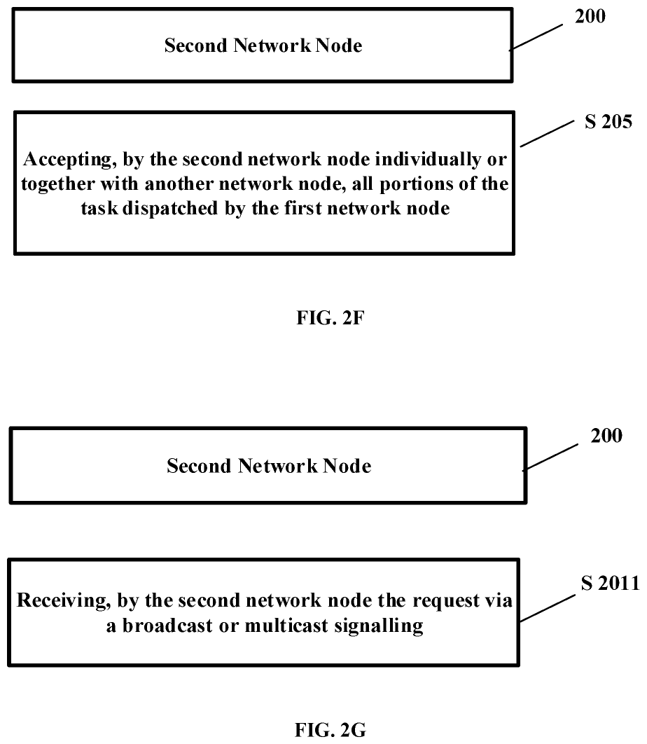

FIG. 2A is an exemplary flow chart showing a method performed at a second network node, according to embodiments of the present disclosure.

Besides the method performed at the first network node, embodiments of the present disclosure further provides a method at a second network node, comprising: S201, receiving, by the second network node, from a first network node, a request of dispatching a task; S202, transmitting, by the second network node, to the first network node, a response of accepting the task; S203, receiving, by the second network node, from the first network node, at least one portion of the task; and S204, transmitting, by the second network node, to the first network node, a result of executing the at least one portion of the task.

FIG. 2B is an exemplary flow chart showing additional steps of the method performed at the second network node, according to embodiments of the present disclosure.

In embodiments of the present disclosure, the method further comprises: when the task comprises a memory task, S2031, receiving, by the second network node, data to be stored from the first network node, when receiving the at least one portion of the task; and S2041, transmitting, by the second network node, the data to the first network node, when transmitting a result of executing the at least one portion of the task.

FIG. 2C is an exemplary flow chart showing additional steps of the method performed at the second network node, according to embodiments of the present disclosure.

In embodiments of the present disclosure, the method further comprises: when the task comprises a computation task, S2032, receiving, by the second network node, data to be processed with information about an algorithm for processing the data from the first network node, when receiving the at least one portion of the task; S2042, transmitting, by the second network node, a result of processing the data to the first network node, when transmitting a result of executing the at least one portion of the task.

FIG. 2D is an exemplary flow chart showing additional steps of the method performed at the second network node, according to embodiments of the present disclosure.

In embodiments of the present disclosure, the computation task comprises an artificial intelligence task.

In embodiments of the present disclosure, the method further comprises: when the artificial intelligence task comprises a training or inferring task for a plurality of models, S20321, receiving, by the second network node, information about a model of the plurality of models from the first network node, when receiving at least one portion of the task; wherein the plurality of models are transmitted to a plurality of second network nodes, respectively.

FIG. 2E is an exemplary flow chart showing additional steps of the method performed at the second network node, according to embodiments of the present disclosure.

In embodiments of the present disclosure, the method further comprises: when the artificial intelligence task comprises a training or inferring task for a model with a plurality of data sets, S20322, receiving, by the second network node, the model and a data set of the plurality of data sets from the first network node, when receiving at least one portion of the task; wherein the model is transmitted to a plurality of second network nodes; and wherein the plurality of data sets are transmitted to the plurality of second network nodes, respectively.

FIG. 2F is an exemplary flow chart showing additional steps of the method performed at the second network node, according to embodiments of the present disclosure.

In embodiments of the present disclosure, the method further comprises: S205, accepting, by the second network node individually or together with another network node, all portions of the task dispatched by the first network node.

In embodiments of the present disclosure, the request of transmitting the task includes information about at least one of: a type of the task; a deadline requirement of the task; an estimate of resources required by the task; a transport bandwidth for transmitting and/or receiving; or a duration of the task.

FIG. 2G is an exemplary flow chart showing additional steps of the method performed at the second network node, according to embodiments of the present disclosure.

In embodiments of the present disclosure, the method further comprises: S2011, receiving, by the second network node the request via a broadcast or multicast signalling.

In embodiments of the present disclosure, the second network node comprises a core network node and/or a server.

According to embodiments of the present disclosure, the first network node may dispatch at least one portion of a task to second network node, so as to dynamically manage the load of the first network node itself. The first network node itself may need not to be upgraded greatly, even when relevant processing loads increase.

Further, the second network node may be deployed without circumstance limitation of the first network node. For example, the first network node may be an access network node with limitation of volume and cost, but the second network node may be a powerful server for general purpose and may be easily upgraded with new storage elements and processing elements.

According to embodiments of the present disclosure, it is possible for any unspecified second network node (with storage and/or computation capability) to provide assistance to the first network node. It should be understood, the second network node may also receive the request via a dedicated signalling/message.

Further, some embodiments of the present disclosure specifically target to enable AI capability in legacy cellular networks implementation.

AI has created a great business momentum in the telecom industry. AI deployment in radio networks (e.g. LTE and NR) have been studied worldwide and grown fast. AI assistant radio network is designed to support very efficient radio resource handling and low device energy consumption, and of course allowing for more applications. Another key advantage is that the AI can greatly reduce manual configuration and reduce OPEX (operation expense) via automatically RAN self-configuration.

To be able to cope with the peak demand from both eMBB and AI, embodiments of the present disclosure propose a method for managing load of network node, particularly for offloading AI processing task. The method may dispatch tasks, such as AI processing tasks, from the overloaded network node, such as a DU (digital unit), to other computing nodes, e.g. servers at Edge sites. In this way, some tasks (e.g. AI processing task) is offloaded to other nodes and thus the competition between eMBB and AI processing is relieved.

There are multiple AI specific load characteristics, which is different on legacy wireless-communication eMBB traffic load.

AI normally has high requirement on memory and relative long storage time (e.g. data should be kept at level of hours or even days). Reason of this high and long-duration storage is AI in principle learns from large amounts of historical data. While processing telecommunication service, like gNB, router and switcher focus on high throughput hence limited in data storage and very short storage duration (at level of macro-second).

eMBB processing is sequential. For example, for downlink traffic, only after scheduling, channel coding can start, and then only after channel coding is finished, modulation can start. While AI well support processing/data parallelism.

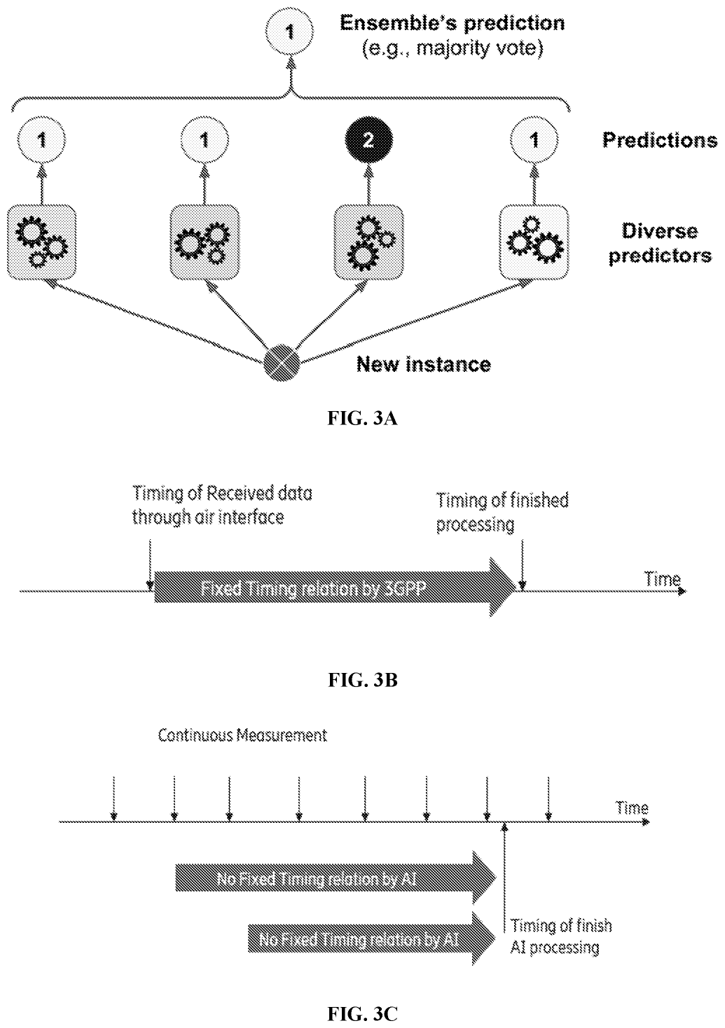

FIG. 3A is an exemplary diagram showing a processing parallelism.

Processing parallelism is normally used in multi prediction ensemble algorithm, like random forest etc.

As shown in FIG. 3, multiple (diverse) predictors will make predictions to the same (new) instance but with different algorithm or same algorithm but different random seed. Final output of the ensemble's prediction (e.g. 1) will be an ensemble (or vote) result based on multiple predictors' outputs (e.g., 1, 1, 2, 1).

This technology is called ensemble learning. In this case, parallel processing of each predictors is applicable.

Alternatively, data parallelism is another kind of parallelism mechanism, and can be applied for non-ensemble learning algorithm, e.g. neural network training. All parallel computing nodes may be trained over different slices of input data in sync, and aggregate gradients at each step.

For eMBB traffic, due to special requirement on hardware, most of processing, especially those computation-density function need special-designed co-processor or accelerator to handle. This means DU load (e.g. channel coding) can be only dispatched to DU and hardly dispatched to CU (central unit). On the contrary, due to widely deployed AI industry, AI task can be well supported in most popular hardware platforms, such as common platform, like CPU (Central Processing Unit), GPU (Graphic Processing Unit), and some specific platform, like ASIC (Application Specific Integrated Circuit) (gNB), TPU (Tensor Processing Unit) and FPGA (Field Programmable Gate Array) etc.

On the other hand, with fast-developing AI open-source platform, most software platforms can support AI. This will make AI easier to be dispatched to different kinds of computation node even though they are not dedicatedly designed for AI. It can be CU, Edge computation cloud, or even new version of gNB (which is equipped with AI capability).

AI mainly focus on non-real-time or near-real-time processing, and it is more delay tolerant than the eMBB processing. Normally, non-real-time AI processing control loop takes second level, while near-real-time AI processing control loop takes 10 to 100 mill-seconds. While eMBB traffic load, e.g. scheduling or channel coding takes 0.5 ms. Offload overhead and transport latency will block eMBB from offloading due to too short latency requirement. It is possible for AI to find many computing nodes (e.g. servers at Edge sites) which would fulfil the delay budget requirement for offload.

FIG. 3B is an exemplary diagram showing a fixed time relationship between the start and end of the processing.

As shown in FIG. 3B, for eMBB processing, start time and finished time are all defined by 3GPP (for example once gNB send out an uplink scheduling grant, how long it will receive an uplink transmission from UE and how long gNB should feedback ACK/NACK are all already defined). Its processing budget is a fixed value.

FIG. 3C is an exemplary diagram showing no fixed time relationship between the start and end of the processing.

AI care more about deadline of result, its start time is flexible compared with eMBB traffic.

As shown in FIG. 3C, for AI, its input may be measurement/feedback of wireless network, making decision/output based on latest data or ‘old’ data may have some impacts to performance but still works or its processing/latency requirement can be loosed by compensation of performance.

If some AI tasks executed locally (e.g. need less processing time), it can consider more latest measurement (shorter one), while some AI tasks executed remotely and need long processing and transport time, its performance may degrade but still works (longer one).

Accordingly, embodiments of the present disclosure suggest AI based load distribution mechanism.

AI Load to be distributed, includes memory storage load and/or computations load. AI Load can be distributed to other nodes according to host and neighbor capacity.

Host gNB decides how to further divide AI computation load among in multiple nodes.

For some parallel algorithm, like random forest, host gNB will select a specific predictor or a group of predictors within forest and distributed in a specific node. Host gNB is also responsible for ensemble prediction result together.

For data parallelism, host gNB divide training data into multiple slices and distribute different node with different slices, all nodes process in sync and host gNB is responsible for aggregating gradients from each node.

For AI security and extensibility, different computing node may have different architecture (e.g. some are X86 CPU, some are FPGA). Difference may be invisible to gNB, but gNB can query/apply computation/storage capability via standard interface.

Processing on distributed node is stateless, which means other computing nodes who execute the task does not need to keep the task context information. For example, it only helps the gNB store some data, but has no idea about how to interpret the data.

Host gNB will only inform distributed computing node about expected deadline of processing and distributed node will independently start AI processing according to its own processing capability and transport latency.

In this way, various tasks can be independently dispatched to multiple neighboring nodes. Such computing nodes include but not limited to: gNB/eNB, servers used for edge computation; CU (central unit) in CU-DU split deployment following the 3GPP specified functional split servers, which is deployed by operators for operation and maintenance purpose.

According to embodiments of the present disclosure, the peak capacity of each DU in both eMBB and AI may be increased by offloading AI tasks to other computing nodes with spare resources. It is further potential to enable more advanced AI algorithms enhancing RAN performance with more resources available in other computing nodes. It is compatible to current LTE/NR architecture, and can be achieved by software updates. A large resource pool may be created for offloading AI tasks on demand, and thus it may be flexible to support traffic burst, especially long bursts which has high memory requirement.

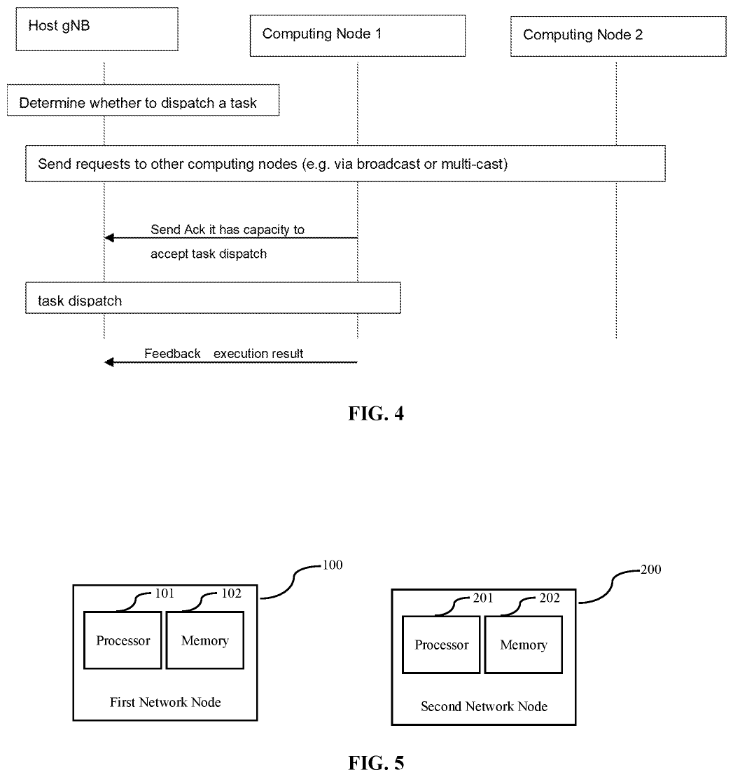

FIG. 4 is a diagram showing an exemplified processing flow for task dispatch, according to embodiments of the present disclosure.

As shown in FIG. 4, a general processing flow is shown for illustrating a general method for offloading tasks to other computing nodes.

In step 1, the host gNB should determine whether to dispatch a task to the other node,

In step 2, host gNB send request to neighboring node.

In step 3, other nodes send acknowledgements (ACK) back to host gNB.

In step 4, if other nodes accept the request, host gNB will dispatch task to neighboring node.

In step 5, neighboring node should feedback execution result to host gNB.

Further, for different task types, such as memory/storage task, or computation/processing task, different details may be illustrated below. Particularly, some special details are further introduced for AI in each step.

In step 1, host gNB determines dispatched tasks.

As to memory task, firstly, gNB continuously monitor its own processing resources. Different with legacy offloading, AI normally has high requirement on memory and relative long storage time (e.g. data should be kept at level of hours or even days).

Host gNB should evaluate memory utilization not only based on its memory size but also occupation time.

For example, gNB should divided memory into 2 partition (e.g. through manual setting) with a specific threshold for each memory partition.

Partition A targets for long-term memory utilization. Historical information that AI requires for more than 30 minutes can be stored in partition A only. This partition may be 10% of total memory.

Partition B targets for middle-term memory utilization. For example, some AI neural network weights will be updated several seconds, and can be stored in partition B only. This partition may be 20% of total memory.

Other short-term memory allocation can be applied in whole memory on-demand.

If gNB found whole memory or a specific memory partition is overflowed, it will generate memory offloading task and request help from other nodes.

As to computation task, instead of packing whole AI into one box (which is actually hard to distribute since box is possibly too big to be taken over), host should split AI computation task according to its parallel capability.

For example, as to parallel algorithm, some algorithms are in nature parallel. A typical example is a group of predictor ensemble algorithm like random forest, bootstrap aggregating.

In details, it can be further divided into 2 subsets. One is collection of a diverse set of predictors, which use very different training algorithms. Host gNB should estimate the working load for each predictor and dispatch them separately. Another approach is to use the same training algorithm for every predictor, but to train them on different random seed (status). gNB should not only estimate the working load for each predictor but also determine the random seed.

For example, as to data parallelism, even some AI algorithms are not ensemble of multiple algorithms. Its training procedure can be still executed in parallel by data parallelism. Host gNB divide training data into multiple slices and distribute different node with different slices, all nodes process in sync and host gNB is responsible for aggregating gradients from each node. gNB should not only estimate the working load for each predictor but also determine the subset of training data.

In step 2, source DU sends task-dispatch requests to other computing nodes.

Once gNB determines the need to offload and split AI task into multiple sets, it sends a task dispatch requirement-list request to other computing nodes who is reachable to the gNB.

This request may include the following information: task type, for example, neural network processing, data store etc; task deadline requirement; estimate of the computation/memory resources required by the task; task dispatch required transport bandwidth; and/or task duration.

One example is AI task dispatch request for AI based power control with following parameters.
Task type: Neural network prediction;
Task latency Requirement: 300 ms (i.e. required feedback 100 ms after accept the request);
Task occupied computation/memory resource: 100 subtasks, each subtask occupies 40,000 float32-value computation, and 30 KB memory.

Another example is AI task dispatch request for data storage with following parameters.
Task type: Data storage;
Task Duration Requirement: 15 mins;
Task occupied memory resource: 300 KB memory;
Task dispatch required transport bandwidth: 30 Mbps.

In step 3, other computing nodes send acknowledgements (ACK) back to source DU.

After other computing nodes receive the task dispatch request, they will evaluate its own processing capacity and determine if it can execute this task with their available processing capacity.

If it can execute, it will send ACK to the source DU indicating the intention to accept this task assignment, and how many subtasks it can take.

If it can't execute, it can send a NACK (non-acknowledgement) to the source DU or do not send anything back, indicating it will not accept the request.

In step 4, task is dispatched from source DU to the selected offloading computing node (or nodes).

If no ACK are received from other computing nodes (i.e. no ACK within a certain period), the source DU will trigger legacy overload avoidance mechanisms by RRC message (e.g. reject UE's access request by admission control) or directly abandon this AI task.

If ACKs from one or multiple computing nodes are received, the source DU will select candidate lists of computing nodes (if multiple ACKs received) for offloading and dispatch the tasks to the selected node(s).

When dispatching the task, the source DU sends not only the task data but also the task context information which are required to process the data. This is to make the offload processing flexible and stateless. Any computing node can process a task, if the necessary context information is also received. The computing node doesn't need to keep this information, as each task dispatch will include the context info. In this way, multiple tasks can be dispatched to different nodes. Of course, if multiple the same kind of tasks are dispatched to the same computing node, they can share one context info (e.g. sent only with the first task) for a short period.

The task data and task context info can be sent in separate packets, but with a common ID in a field in the payload header. Thus, the computing node can recognize the corresponding task context information for any specific task.

In step 5, results are feedbacked from the offloading computing node to source DU.

The computing node for offloading receives the task from the source DU. Then it will execute the task and it will send the processing result to the source DU.

FIG. 5 is a block diagram showing exemplary apparatuses suitable for practicing the network node according to embodiments of the disclosure.

As shown in FIG. 5, the first network node 100 may comprise: a processor 101; and a memory 102. The memory 102 contains instructions executable by the processor 101, whereby the network node is operative to: determine whether to dispatch a task to another network node; transmit, to at least one network node including a second network node, a request of dispatching the task; receive, from the second network node, a response of accepting the task; transmit, to the second network node, at least one portion of the task; and receive, from the second network node, a result of executing the at least one portion of the task.

Further, the first network node 100 may be operative to perform the method according to any of the above embodiments, such as these shown in FIG. 1A-1H.

As shown in FIG. 5, the second network node 200 may comprise: a processor 201; and a memory 202. The memory 202 contains instructions executable by the processor 201, whereby the network node is operative to: receive, from a first network node, a request of dispatching a task; transmit, to the first network node, a response of accepting the task; receive, from the first network node, at least one portion of the task; and transmit, to the first network node, a result of executing the at least one portion of the task.

Further, the second network node 200 may be operative to perform the method according to any of the above embodiments, such as these shown in FIG. 2A-2G.

The processors 101, 201 may be any kind of processing component, such as one or more microprocessor or microcontrollers, as well as other digital hardware, which may include digital signal processors (DSPs), special-purpose digital logic, and the like. The memories 102, 202 may be any kind of storage component, such as read-only memory (ROM), random-access memory, cache memory, flash memory devices, optical storage devices, etc.

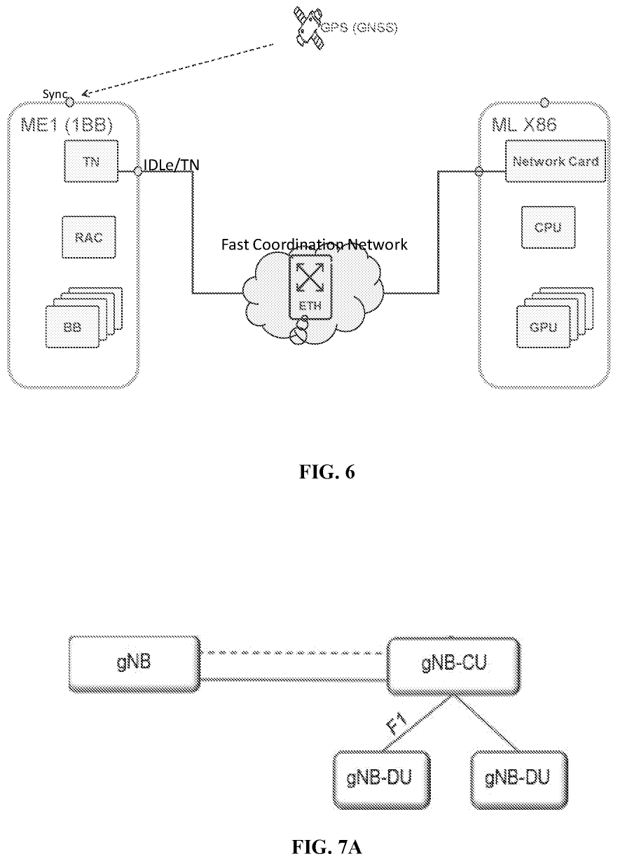

FIG. 6 is a block diagram showing exemplary detailed apparatuses suitable for practicing the network node according to embodiments of the disclosure.

Embodiments have been implemented in testbed as shown in FIG. 6.

A legacy DU may have some fast ethernet port which support high bandwidth and low latency data exchange. The ME1 (mobile equipment) may have baseband (BB) unit, Radio Admission Control (RAC) unit, TN (transport network).

With commercial ethernet, Edge node (here is X86 PC in figure for machine learning, ML) can exchange data with DU. A Xcede interface cable may be used to connect DU with edge node, via a fast coordination network, such as an ethernet.

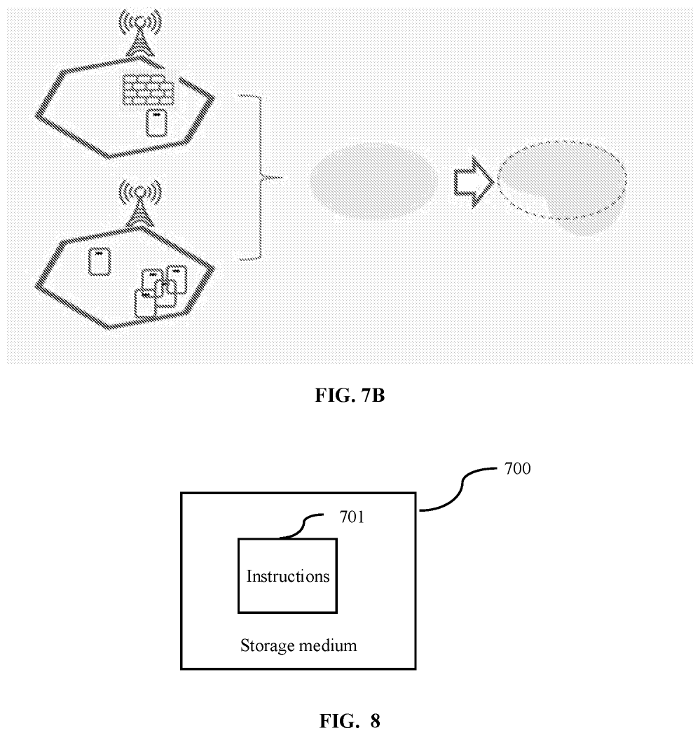

FIG. 7A is an exemplary diagram showing an offload scenario, according to embodiments of the disclosure.

A first scenario may concern an offload to severs at gNB-CU sites.

For example, in 5G, the base station can be split into two parts, a central unit (CU) and one or more distributed units (gNB-DU) using the F1 interface, as illustrated in FIG. 7A. In this case, the upper layer RAN protocols, like RRC (radio resource control), PDCP(packet data convergence protocol), and SDAP (service data adaptation protocol) protocols, reside in the gNB-CU and the remaining protocol entities (RLC (radio link control), MAC (medium access control), PHY (physical)) in the gNB-DU. Normally gNB-DU is located near the antenna and distributed in RAN network, while gNB-CU is located at a remote place providing centralized upper-layer processing for multiple gNB-DUs. gNB-CUs are usually virtualized and hosted on servers based on general purpose processors (e.g. X86 or ARM CPU, GPU, FPGA etc.). These servers can be used to offload AI processing tasks. One benefit is that these servers usually have more computing power and memory than DUs. But the transport delay (on 5 ms level) between DU and servers at the gNB-CU sites is normally longer than the DU-Edge offload case. However, this is tolerable for some key AI tasks.

Another scenario may concern an offload to edge computing nodes at the edge.

Edge computing is an emerging trend in telecom industry. Operators will deploy Edge computing nodes (e.g. servers) based on general purpose processors at the Edge close to base stations to host a varieties of Edge applications which would create new value-added services like VR (virtual reality)/AR (augmented reality) and create new revenues. Such Edge computing nodes may be deployed co-located with DUs at the cell sites or at a central location in C-RAN (Centralized radio access network) deployment. They may be deployed in a separate location than DUs, e.g. at central offices (CO). They may be co-located with gNB-CUs at the gNB-CU sites. One benefit is that these Edge computing nodes usually have more computing power and memory than DUs.

FIG. 7B is an exemplary diagram showing a task for adjusting a coverage of the network, according to embodiments of the disclosure.

As in the user case shown in FIG. 7B, ML is used to detect cell coverage requirement and generate common control channel beam shape to best fit the coverage requirement.

For a specific site, there are some specific penetration loss in some directions. For example, a loss may be caused by a wall or a building. It is desired that cell common control channel specifically focus energy on this direction to improve coverage. Another issue is there is a hot spot in some specific direction, it is also desired to increase common control channel in this direction, which make most of UE consume less common control resources.

To achieve this, gNB should detect UE location and its pathloss, this location+pathloss information should be accumulated for several minutes to guarantee all connected UE has been considered. This information will be measured and updated per 100 ms according to current gNB implementation. Each 100 ms, gNB should update the measurement of UE location.

Every 3 mins, gNB will trigger ML to generate new common control channel beam shape based on latest measurement (100 ms update measurement once, totally 1800 measurements together to calculate new cell shape)

Then, gNB first request memory offloading Request, for example, with following forms.

| | |
|---|---|
| ML_Offloading_Mem_req::= | SEQUENCE { |
| Offloading-ID | ID, |
| Offloading-Duration | 300 second, |
| Offloading-Resource | 40 Mbits, |
| Offloading-BW | 200 kbit/second |
| Offloading_backward_BW | 80000 kbits/second |

}

If edge node ACK, it will allocate a memory block with max size of 8 Mbits for 5 minutes (after 5 minutes, memory will be released. Here 5 mins instead of 3 mins, reserves enough time for transport delay and gNB processing delay. gNB will transfer all measurement to edge immediately without local storage, and data exchange bandwidth (from gNB to Edge) need peak less than 200 kbit/second.

And once gNB want to fetch back data for ML processing, (from Edge to gNB), gNB will first try to find/reserve processing load for ML, and with success allocation ML computation resource at gNB, gNB will fetch back data from edge, with peak rate of 50 Mbps. The following forms may be utilized.

| | |
|---|---|
| ML_Fetchback_Mem_req::= | SEQUENCE { |
| Offloading-ID | ID, |

}

FIG. 8 is a block diagram showing an apparatus readable storage medium, according to embodiments of the present disclosure.

As shown in FIG. 8, the computer-readable storage medium 700, or any other kind of product, storing instructions 701 which when executed by at least one processor, cause the at least one processor to perform the method according to any one of the above embodiments, such as these shown in FIG. 1A-2G.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

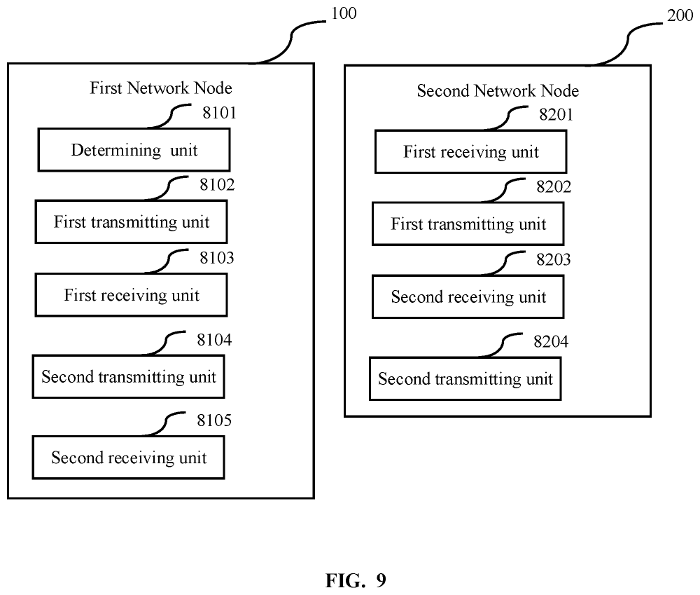

FIG. 9 is a schematic showing units for the network node, according to embodiments of the present disclosure.

In embodiments of the present disclosure, the first network node 100 may comprise: a determining unit 8101, configured to determine whether to dispatch a task to another network node; a first transmitting unit 8102, configured to transmit, to at least one network node including a second network node, a request of dispatching the task; a first receiving unit 8103, configured to receive, from the second network node, a response of accepting the task; a second transmitting unit 8104, configured to transmit, to the second network node, at least one portion of the task; and a second receiving unit 8105, configured to receive, from the second network node, a result of executing the at least one portion of the task.

In embodiments of the present disclosure, the terminal device is further operative to perform the method according to any of embodiments above described.

In embodiments of the present disclosure, the second network node 200 may comprise: a first receiving unit 8201, configured to receive, from a first network node, a request of dispatching a task; a first transmitting unit 8202, configured to transmit, to the first network node, a response of accepting the task; a second receiving unit 8203, configured to receive, from the first network node, at least one portion of the task; and a second transmitting unit 8204, configured to transmit, to the first network node, a result of executing the at least one portion of the task.

In embodiments of the present disclosure, the terminal device is further operative to perform the method according to any of embodiments above described.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the network node 100, 200 may not need a fixed processor or memory, any computing resource and storage resource may be arranged from at least one network node/device/entity/apparatus relating to the communication system. The virtualization technology and network computing technology (e.g. cloud computing) may be further introduced, so as to improve the usage efficiency of the network resources and the flexibility of the network.

For example, when a task is offloaded to Edge Computing nodes, the BB software executing offloaded tasks can be virtualized running in a Cloud (or Edge Cloud) environment.

According to embodiments herein, a network node may dispatch at least one portion of a task to another network node, so as to dynamically manage the load of the network node itself. The network node itself may need not to be upgraded greatly, even when relevant processing loads increase.

Particularly, a DU may dispatch AI tasks to other computing nodes for processing offload. DU may send task data along with task context information which are required to execute the task. Other computing nodes may use the task context information to process the task data and feedback the results.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Particularly, these function units may be implemented either as a network element on a dedicated hardware, as a software instance running on a dedicated hardware, or as a virtualized function instantiated on an appropriate platform, e.g. on a cloud infrastructure.

In general, the various exemplary embodiments of the present disclosure may be implemented in hardware or special purpose circuits, software, logic or any combination thereof. For example, some aspects may be implemented in hardware, while other aspects may be implemented in firmware or software that may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may include circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

| Abbreviation | Explanation |
|---|---|
| UE | User equipment |
| LTE | Long term evolution |
| DL | Downlink |
| UL | Uplink |
| 5G | 5th generation of radio network |

1. A method performed at a first network node, comprising:
determining, by the first network node, whether to dispatch a task to another network node;
transmitting, by the first network node, to at least one network node including a second network node, a request of dispatching the task;
receiving, by the first network node, from the second network node, a response of accepting the task;
transmitting, by the first network node, to the second network node, at least one portion of the task; and
receiving, by the first network node, from the second network node, a result of executing the at least one portion of the task.

2. The method of claim 1, wherein
the task comprises a memory task, and
the method further comprises:
transmitting, by the first network node, data to be stored to the second network node, when transmitting the at least one portion of the task; and
receiving, by the first network node, the data from the second network node, when receiving a result of executing the at least one portion of the task.

3. The method of claim 1, the method further comprising:
determining, by the first network node, whether to dispatch the task, based on an evaluation about a memory size and/or an occupation period of a memory of the first network node, wherein
the first network node determines to dispatch the task, when at least one partition of the memory is to be overflowed.

4. (canceled)

5. The method of claim 1, wherein the first network node comprises a first partition of a memory for a first occupation period; and/or a second partition of a memory for a second occupation period.

6. The method of claim 1, wherein
the task comprises a computation task, and
the method further comprises:
transmitting, by the first network node, data to be processed with information about an algorithm for processing the data to the second network node, when transmitting at least one portion of the task; and
receiving, by the first network node, a result of processing the data from the second network node, when receiving a result of executing the at least one portion of the task.

7. (canceled)

8. The method of claim 6, wherein
the computation task comprises an artificial intelligence task,
the artificial intelligence task comprises a training or inferring task for a plurality of models, and
the method further comprises:
transmitting, by the first network node, information about a model of the plurality of models to the second network node, when transmitting at least one portion of the task; and
transmitting, by the first network node, the plurality of models to a plurality of second network nodes, respectively.

9. The method of claim 6, wherein
the computation task comprises an artificial intelligence task,
the artificial intelligence task comprises a training or inferring task for a model with a plurality of data sets, and
the method further comprises:
transmitting, by the first network node, the model and a data set of the plurality of data sets to the second network node, when transmitting at least one portion of the task;
transmitting, by the first network node the model to a plurality of second network nodes; and
transmitting, by the first network node, the plurality of data sets to the plurality of second network nodes, respectively.

10. The method of claim 1, the method further comprising:
dispatching, by the first network node, all portions of the task to the second network node; or
dispatching, by the first network node, a plurality of portions of the task to a plurality of second network nodes respectively.

11. The method of claim 1, wherein the request of dispatching the task includes information about:
a type of the task;
a deadline requirement of the task;
an estimate of resources required by the task;
a transport bandwidth for transmitting and/or receiving; and/or
a duration of the task.

12. The method of claim 1, the method further comprising:
transmitting, by the first network node, the request via a broadcast or multicast signalling, wherein
the first network node comprises an access network node.

13. (canceled)

14. A method performed at a second network node, comprising:
receiving, by the second network node, from a first network node, a request of dispatching a task;
transmitting, by the second network node, to the first network node, a response of accepting the task;
receiving, by the second network node, from the first network node, at least one portion of the task; and
transmitting, by the second network node, to the first network node, a result of executing the at least one portion of the task.

15. The method of claim 14, wherein
the task comprises a memory task, and
the method further comprises:
receiving, by the second network node, data to be stored from the first network node, when receiving the at least one portion of the task; and
transmitting, by the second network node, the data to the first network node, when transmitting a result of executing the at least one portion of the task.

16. The method of claim 14, wherein
the task comprises a computation task, and
the method further comprises:
receiving, by the second network node, data to be processed with information about an algorithm for processing the data from the first network node, when receiving the at least one portion of the task; and
transmitting, by the second network node, a result of processing the data to the first network node, when transmitting a result of executing the at least one portion of the task.

17. (canceled)

18. The method of claim 16, wherein
the computation task comprises an artificial intelligence task,
the artificial intelligence task comprises a training or inferring task for a plurality of models,
the method further comprises receiving, by the second network node, information about a model of the plurality of models from the first network node, when receiving at least one portion of the task; and
the plurality of models are transmitted to a plurality of second network nodes, respectively.

19. The method of claim 16, wherein
the computation task comprises an artificial intelligence task,
the artificial intelligence task comprises a training or inferring task for a model with a plurality of data sets,
the method further comprises receiving, by the second network node, the model and a data set of the plurality of data sets from the first network node, when receiving at least one portion of the task,
the model is transmitted to a plurality of second network nodes, and
the plurality of data sets are transmitted to the plurality of second network nodes, respectively.

20. The method of claim 14, the method further comprising:
accepting, by the second network node individually or together with another network node, all portions of the task dispatched by the first network node.

21. The method of claim 14, wherein the request of transmitting the task includes information about:
a type of the task;
a deadline requirement of the task;
an estimate of resources required by the task;
a transport bandwidth for transmitting and/or receiving; and/or
a duration of the task.

22. (canceled)

23. (canceled)

24. A first network node, comprising:
a processor; and
a memory, the memory containing instructions executable by the processor, whereby the first network node is operative to:
determine whether to dispatch a task to another network node;
transmit, to at least one network node including a second network node, a request of dispatching the task;
receive, from the second network node, a response of accepting the task;
transmit, to the second network node, at least one portion of the task; and
receive, from the second network node, a result of executing the at least one portion of the task.

25. (canceled)

26. A second network node, comprising:
a processor; and
a memory, the memory containing instructions executable by the processor, whereby the second network node is operative to:
receive, from a first network node, a request of dispatching a task;
transmit, to the first network node, a response of accepting the task;
receive, from the first network node, at least one portion of the task; and
transmit, to the first network node, a result of executing the at least one portion of the task.

27. (canceled)

28. A non-transitory computer-readable storage medium storing instructions which when executed by at least one processor, cause the at least one processor to perform the method of claim 1.
